(19) United States
(12) Patent Application Publication
(10) Pub. No.: US 2005/0161482 A1
(43) Pub. Date: Jul. 28, 2005

(54) Removably attachable motorcycle luggage

(76) Inventor: Kristopher M. Krohn, Sheboygan, WI (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 10/764,197

(22) Filed: Jan. 23, 2004

(51) Int. Cl. B62J 7/00; B62J 9/00; B62J 11/00

(52) U.S. Cl. 224/413

(57) ABSTRACT

Removably attachable motorcycle luggage is provided having an expandable pocket for securably engaging the seat back or sissy bar of a motorcycle. The expandable pocket is configured to be disposed on a variety of different sized sissy bars and/or makes and models of motorcycles. The pocket is easily collapsible to facilitate transport of the luggage. The motorcycle luggage is also provided with an integral rain cover for protection of the luggage in bad weather.

### BACKGROUND OF THE INVENTION

Field of the Invention

The present invention relates generally to travel luggage, and more specifically to motorcycle luggage that is removably attachable to the seat backs of a variety of types, makes and models of motorcycles.

A significant number of motorcycle owners engage in long distance or cross country touring on their motorcycle each year. Unlike car or airplane travel, one of the most significant problems with motorcycle touring is the limited amount of storage space for carrying personal belongings. Further, motorcycle luggage must be secure, durable and able to withstand variable weather conditions and high speeds without damage to its contents. Importantly, motorcycle luggage must be attachable to the bike without interfering with the driver and without interfering with the center of gravity or balance of the motorcycle.

A number of different motorcycle luggage designs have been developed to deal with the problems of storage on board a motorcycle. These designs include bags that attach to several locations on the motorcycle, such as, bags that rest on the gas tank, saddle bags that hang down on to the sides of the motorcycle, or panniers that hang down on either side of the rear wheel. These designs, however, are bulky, and difficult to remove from the motorcycle. A number of other designs utilize the sissy bar of the motorcycle, a seat back that serves as a back rest for the passenger or the rider, for attachment of travel luggage to the motorcycle.

Previous motorcycle luggage designs that utilize the sissy bar or seat back of the motorcycle lack the ability to easily attach and secure to a number of different types and sizes of motorcycle designs. As a result, manufactures must custom fit each piece of luggage to fit each type/size of sissy bar, making the manufacture of luggage expensive and inefficient. In addition, these designs render luggage ownership a significant expense for riders that possess several different types of motorcycles.

More recently, luggage designs have been developed that may be fitted onto various seat backs or sissy bars; however, these designs require the use of exchangeable or removable pockets and/or extendable, exchangeable straps—rendering them time-consuming and problematic to fit, attach and remove the luggage from the motorcycle. In addition, these designs are typically used with awkwardly shaped and bulky bags, which are ascetically unappealing and unsophisticated.

It is accordingly the primary objective of the present invention to provide high-quality, attractive motorcycle luggage that can be easily adjusted to accommodate a number of different makes, models and designs of motorcycles. It can be a related object of the present invention to provide soft motorcycle luggage that is securely fit to a motorcycle sissy bar, easily removed from the motorcycle, and readily transported from location to location, similar to conventional luggage systems.

It can be another objective of the present invention to provide soft, yet rugged motorcycle travel luggage that is capable of withstanding high speeds without exhibiting vibration or interference with the balance or safety of motorcycle operation. It is a related objective of the present invention to provide motorcycle luggage that is able to withstand poor weather conditions without damage to the motorcycle bag or its contents.

The motorcycle luggage of the present invention must also be of construction which is both durable and long lasting, and it should also require little or no maintenance to be provided by the user throughout its operating lifetime. In order to enhance the market appeal of motorcycle luggage should also be of inexpensive construction to thereby afford it the broadest possible market. Finally, it is also an objective that all of the aforesaid advantages and objectives be achieved without incurring any substantial relative disadvantage.

### SUMMARY OF THE INVENTION

The disadvantages and limitations of the background art discussed above are overcome by the present invention. With this invention, motorcycle travel luggage is provided including a novel luggage mounting system for securing the luggage to a motorcycle. The luggage mounting system includes an adjustable pocket affixed to the luggage for tightly securing the luggage to the sissy bar of a motorcycle. The adjustable pocket is expandable to fit sissy bars having a wide variety of dimensions and is easily collapsible to a flat or closed position when the luggage is not mounted to the motorcycle.

The adjustable pocket of the motorcycle luggage of the present invention includes a fastening mechanism that allows expansion of the pocket to its maximum volume/fully open position and that also permits collapsing the pocket to its fully closed position. The fastening mechanism provides the pocket with variable dimensions such that the pocket is able to receive and retain sissy bars of different sizes and shapes. Thus, the size of the pocket depends on the degree of closure of the fastening mechanism, which is in turn determined by the size of the sissy bar accommodated therein. Preferably, the fastening mechanism includes one or more zippers.

The motorcycle luggage of the present invention can include tightening straps for securing the pocket around the sissy bar. The straps are adjustable, depending on the size of the sissy bar positioned within the expandable pocket. The motorcycle luggage of the present invention can also include hold down straps that wrap around the frame of the motorcycle to provide added security to the luggage. The hold down straps are provided with quick release fastening mechanisms to easily secure the luggage in place on the motorcycle and to quickly release the luggage when desired.

Optionally, the motorcycle luggage of the present invention can be provided with wheels and an extendable handle to assist in the transport of the luggage. When mounted to the motorcycle, the handle can be retracted and stored within a compartment located at the top of the luggage.

In addition, the motorcycle luggage of the present invention can be provided with a rain cover that completely encloses the luggage for motorcycle travel in bad weather. The rain cover can be integrally connected to the luggage in order to avoid loss of the cover when travelling at high speeds. When not needed, the rain cover can be folded and completely stored within a storage compartment without taking up valuable space within the internal compartment of the luggage itself. The rain cover may, alternatively, be provided separately from the luggage and can be merely stored in a compartment within the luggage.

The motorcycle luggage can include a variety of pockets, pouches and storage compartments. For example, the luggage can include cellular phone compartments, change holders, key hooks, glasses cases or any other storage configuration that would be useful for travel. The internal storage compartment of the luggage can include other items such as mirrors, shelves, hanger hooks, or retaining straps to facilitate packing and unpacking the luggage.

The motorcycle luggage of the present invention is of a construction which is both durable and long lasting, and which will require little or no maintenance to be provided by the user throughout its operating lifetime. The motorcycle luggage of the present invention is also of inexpensive construction to enhance its market appeal and to thereby afford it the broadest possible market. Finally, all of the aforesaid advantages and objectives are achieved without incurring any substantial relative disadvantage.

### DESCRIPTION OF THE DRAWINGS

These and other advantages of the present invention are best understood with reference to the drawings, in which:

FIG. 1 is an isometric view of a first embodiment of the motorcycle luggage of the present invention shown being installed on a motorcycle sissy bar;

FIG. 2 is a front isometric view of the motorcycle luggage shown in FIG. 1, secured to the motorcycle sissy bar;

FIG. 3 is a rear isometric view of the motorcycle luggage shown in FIGS. 1 and 2, illustrating a self-contained rain cover and compartment for retaining same;

FIG. 4 is a rear isometric view of the motorcycle luggage shown in FIGS. 1 through 3, illustrating the rain cover disposed over the motorcycle bag;

FIG. 5 is a rear elevational of the motorcycle luggage shown in FIGS. 1 through 4, with first and second side ends of the motorcycle bag opened;

FIG. 6 is a side elevational view of the motorcycle luggage shown in FIGS. 1 through 5, illustrating the internal structure of the motorcycle bag;

FIG. 7 is a front isometric view of a second embodiment of the motorcycle luggage of the present invention, shown secured to a motorcycle sissy bar;

FIG. 8 is a rear isometric view of the motorcycle luggage shown in FIG. 7, illustrating a self-contained rain cover and compartment for retaining same;

FIG. 9 is an isometric view of the motorcycle luggage shown in FIGS. 7 and 8, illustrating the rain cover disposed over the motorcycle bag;

FIG. 10 is a rear elevational view of the motorcycle luggage shown in FIGS. 7 through 9, shown with the luggage compartment of the motorcycle luggage opened; and

FIG. 11 is a front isometric view of the motorcycle luggage shown in FIGS. 7 through 10, shown with a handle extended.

### DETAILED DESCRIPTION OF THE PREFERRED EMBODIMENT

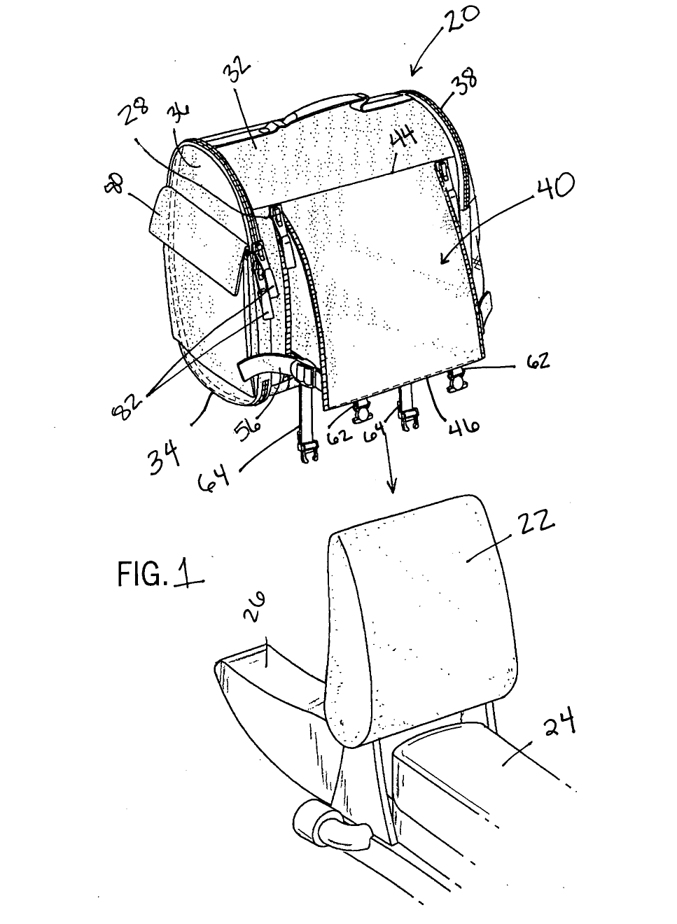

FIG. 1 illustrates the motorcycle luggage 20 (“motorcycle bag”) of the present invention configured to securely and removably attach onto the back rest or sissy bar 22 of a motorcycle 24. The motorcycle bag 20 may rest on the rear frame 26 of the motorcycle 24. The motorcycle bag 20 of the present invention is adaptable to fit a number of different motorcycle sissy bars 32 of various sizes and dimensions and is easily installed and removed from the motorcycle 24.

As best illustrated in FIGS. 1 through 3, the motorcycle bag 20 generally comprises a front side 28, a back side 30, a top side, indicated generally at 32, a bottom side, indicated generally at 34, and side ends 36 and 38, defining an enclosure for storing personal belongings. When the motorcycle bag 20 is installed onto the sissy bar 22, the front side 28 of the bag will be oriented towards the front of the motorcycle 24 and the back side 30 will be oriented towards the back of the motorcycle 24. The bottom side 34 of the motorcycle bag will preferably rest on the rear frame 26 of the motorcycle 24.

The motorcycle bag 20 is constructed, at least in part, of a durable, flexible material that is preferably water resistant, giving the exterior surfaces of the motorcycle bag a “soft” luggage appearance. However, the motorcycle bag 20 may be constructed of any material known in the art for the construction of durable luggage, including “hard” luggage construction materials.

Referring to FIG. 1, an expandable receptacle or pocket 40 is located on the front side 28 of the motorcycle bag 20 and is adapted to securely engage the motorcycle's sissy bar 22. As described herein, the pocket 40 is preferably dimensioned to fit/receive the sissy bars of various models and sizes of motorcycles.

The pocket 40 comprises a flap indicated generally at 42 having a top portion 44, a bottom portion 46 and side edges 48. The top portion 44 is securely attached to the front side 28 of the motorcycle bag 20. Side panels 50 connect each of the side edges 48 of the flap 42 to the front side 28 of the bag 20. As illustrated in the figures, the side panels 50, the flap 42 and the front side 32 of the motorcycle bag 20 form an opening for accommodating the sissy bar 22 of the motorcycle. Each side panel 50 is sized to permit the bottom portion 46 of the flap 42 to extend any distance away from the front side 28 of the motorcycle bag 20, depending on the size pocket 40 desired. It will be readily apparent to those skilled in the art that the side panels 50 can be of any size necessary to accommodate the dimensions of a large number of sissy bar sizes.

The pocket 40 may be constructed and attached to the front side 28 of the motorcycle bag 20 by any means known to those skilled in the art, such as sewing, sonic welding, gluing, tacking or otherwise permanently securing the pocket to the front side 28 of the bag 20. It is consistent with the broader aspects of the present invention, however, that the pocket 40 may be constructed and attached to the front side 28 of the motorcycle bag 20 utilizing less permanent methods of attachment, such as snaps, hooks or Velcro type fastening mechanisms.

Consistent with the broader aspects of the invention, the internal surfaces of the expandable pocket 40 including the flap 42, side panels 50 and/or a portion of the front side 28 of the motorcycle bag 20 (i.e. the portions of the pocket 40 that are in direct contact the sissy bar) may be covered or constructed of a rubberized, non-slip and/or high-friction material. Such a construction provides the motorcycle bag 20 with added protection against slipping.

Zippers 54 located on each of the side edges 48 of the flap 42 secure the flap 42 to the front side 28 of the bag 20 and allow the pocket 40 to be varied in size/volume, depending on the sissy bar to be accommodated. The zippers 54 extend from the top portion 44 of the flap 42 to the bottom portion 46 of the flap 42 and are oriented such that when the zippers 54 are zipped completely closed, the bottom portion 46 of the flap 42 lies flat against the front side 28 of the bag 20. Thus, when the motorcycle bag 20 is not secured to the motorcycle 24, the pocket 40 is flat. In this configuration, the pocket 40 is collapsed down to a minimum volume that does not interfere with the rider moving or carrying the bag and that provides a clean, sharp look to the exterior surface of the motorcycle bag 20.

As illustrated in FIG. 1, when the motorcycle bag 20 is to be installed onto the sissy bar 22, the zippers 54 may be partially or completely unzipped, expanding the pocket 40 (and increasing the volume of the pocket 40) in order to accommodate the sissy bar 22. To secure the motorcycle bag 20 in place, the zippers 54 of the expandable pocket 40 are zipped closed over the sissy bar 22 as far as possible to snugly enclose the sissy bar 22 therein. Thus, depending on the size of the sissy bar 22, the zippers 54 permit the expandable pocket 40 to adjust to securely fit a number of different sized seat backs/sissy bars.

It will be apparent to those skilled in the art that the zippers 28 may be replaced by any type of fastening or closure mechanism known to those skilled in the art. However, the fastening mechanism utilized should be of the type that would permit the pocket 40 to have a variable volume dimension, i.e., the fastening mechanism should be of the type to have multiple closure positions.

Side tightening straps 56 are located on each side of the expandable pocket 40. Each side tightening strap 56 includes an adjustment mechanism 58 so that the strap 56 may be tightened to supplement the pocket 40 in securing motorcycle bag 20 in place on the sissy bar 22. As will be apparent to one skilled in the art, the side tightening straps 56 can be adjusted to accommodate any size sissy bar 22 within the pocket 40 and will be appropriately tightened to secure the motorcycle bag 20 in place. For example, the pocket 40 can be used to securely mount the motorcycle bag 20 to a sissy bar that may be narrower than the pocket 40 by adjusting the side tightening straps 56 to tightly secure the sissy bar before closing the zippers 82. The side tightening straps 56 may be constructed to be detachable from the motorcycle bag 20 for easy storage when use of the straps 56 is not required.

The motorcycle bag 20 also includes hold down straps 60 that wrap around the frame of the motorcycle's sissy bar 22 to additionally secure the motorcycle bag 20 in place. As best illustrated in FIG. 1, each hold down strap 60 includes a first segment 62 attached at one end to the bottom portion 46 of the flap 42 and a second segment 64 attached at one end to the front side 28 of the motorcycle bag 20. Alternatively the second segment 64 of the hold down strap 60 may be attached to the bottom side 34 of the motorcycle bag 20. A quick release fastening mechanism 66 is attached to each of the first and second segments 62, 64 of each hold down strap 60 on the free end thereof, releasably joining each first segment 62 to each second segment 64. The fastening mechanism 66 may be a buckle, clasp, snap or any other quick release fastening mechanism known to those skilled in the art. The hold down straps 60 may be constructed to be detachable from the motorcycle bag 20 for easy storage when not in use.

As described above, the motorcycle bag 20 of the present invention is easily secured to the motorcycle's sissy bar 22 by means of the expandable pocket 40, and straps 56 and 60. This mounting system provides for luggage that will not vibrate or otherwise interfere with operation of the motorcycle during travel. Further, the motorcycle bag 20 of the present invention is also easily removed from the motorcycle for transport from location to location and conveniently carried via a handle 67 located on the top side 32 of the bag 20. The expandable pocket 40 and straps 56 and 60 are readily collapsed and/or stored out of the way to facilitate transport of the motorcycle bag 20.

Referring next to FIG. 3, the back side 30 of the motorcycle bag 20 is shown. The back side 30 includes a pocket 68 for storing additional items. Straps 70 are also included for securing the pocket 68 closed and for attaching additional items to the motorcycle bag 20 during travel. Consistent with the broader aspects of the present invention, the pocket 68 can be replaced with any type or sized pouch or receptacle for storing items.

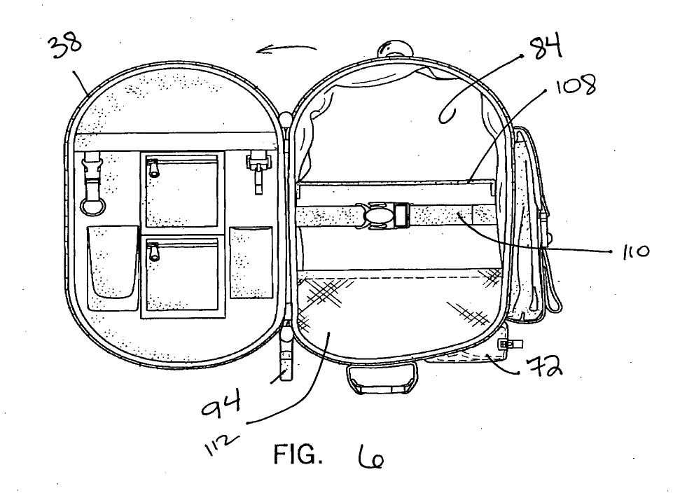

The back side 30 of the motorcycle bag 20 also includes a zippered compartment 72 that retains a rain cover 74, as shown in FIG. 5. When not in use, the rain cover 74 can be folded up and completely stored within the compartment 72, as shown in FIG. 5. An element 76 connects the rain cover 74 within the compartment 72 and secures the rain cover 74 to the motorcycle bag 20. Preferably, the element 76 is constructed of a resilient or elastic material to facilitate positioning of the rain cover on to the motorcycle bag 20. Alternately, the rain cover 74 can be entirely separate from the motorcycle bag 20, but stored within the compartment 72. The rain cover 74 also includes drawstring or elastic portion 78 that can be used to tighten and secure the rain cover 74 around the motorcycle bag 20 when the rain cover 74 is installed.

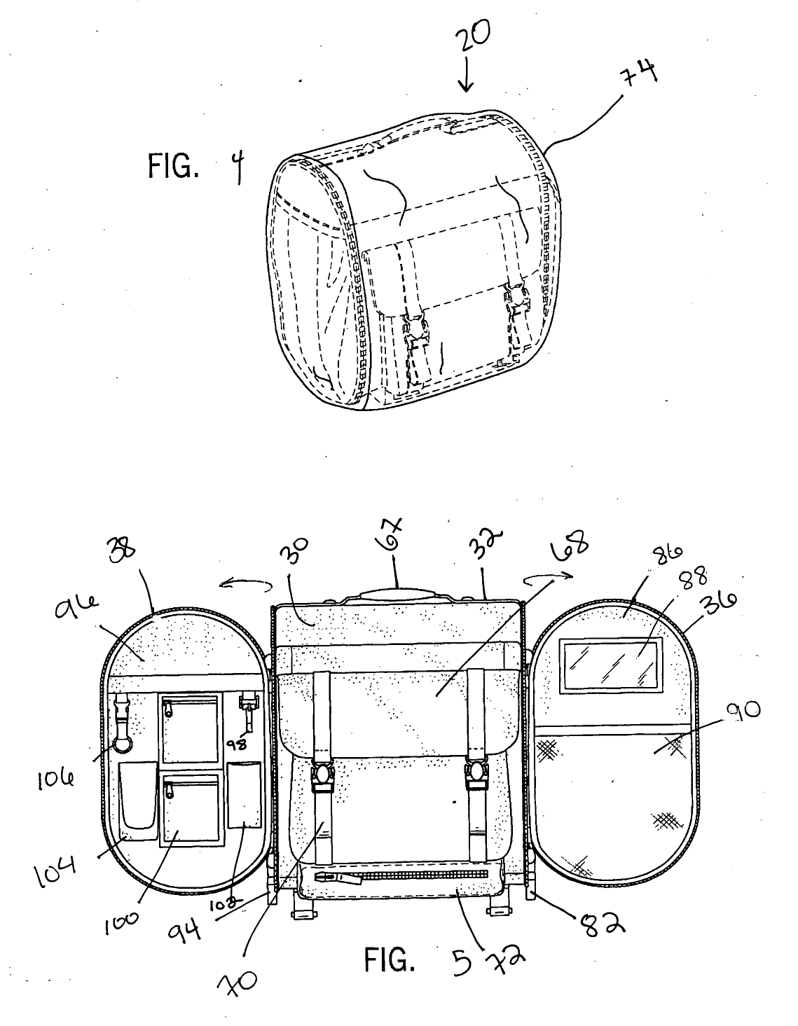

FIG. 4 best illustrates the rain cover 74 installed over the motorcycle bag 20. As illustrated, the rain cover 74 completely covers the motorcycle bag 20 protecting the motorcycle bag 20 and the personal belongings of the rider from damaging weather conditions.

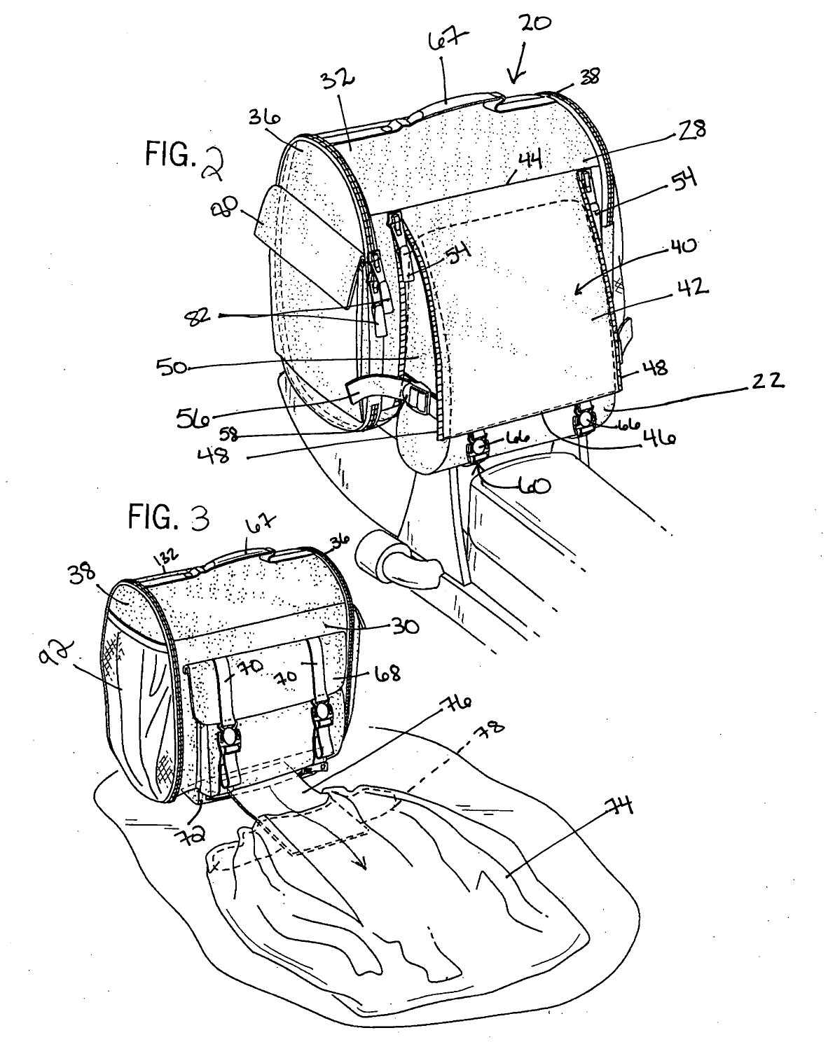

As illustrated in FIGS. 1 and 2, a storage pocket 80 is located on the side end 36 of the motorcycle bag 20 for storing items on the exterior of the motorcycle bag 20. Alternatively, the pocket 80 can be replaced with any type or sized pouch or receptacle for storing items on the exterior surface of the motorcycle bag 20.

Referring to FIG. 5, in addition to FIGS. 1 and 2, the motorcycle bag 20 can be opened for packing and unpacking the motorcycle bag 20 using zippers 82 that are provided on the side end 36. As best shown in FIG. 6, the side end 36 completely opens exposing an interior compartment 84. In addition, the side end 36 has an interior surface 86 including a mirror 88 and a pouch 90 for convenient access by the user.

As illustrated in FIG. 3, a pouch 92 is located on the side end 38 of the motorcycle bag 20 for storing additional items on the exterior surface of the motorcycle bag 20. Alternatively, the pouch 92 can be replaced with any type or sized pocket or receptacle for storing items on the exterior surface of the motorcycle bag 20.

Referring to FIGS. 5 and 6, in addition to FIG. 3, the motorcycle bag 20 can be opened for packing and unpacking the motorcycle bag 20 using zippers 94 that are provided on the side end 38. Like the side end 36, the side end 38 completely opens exposing the interior compartment 84. The side end 38 has an interior surface 96 including a plurality of storing and retaining devices, such as a key hook 98, change compartments 100, glasses case 102, cellular phone compartment 104 and clips 106 for convenient access by the user. As will be readily apparent to those skilled in the art, the internal surfaces 86 and 96 may include any type and/or configuration of pockets, pouches, compartments, clips, hooks and/or storage means known to those skilled in the art.

As illustrated in FIG. 6, the interior compartment 84 is configured to efficiently accommodate a large volume of personal belongings. Accordingly, the interior compartment a shelf 108, a retaining strap 110 and a retaining panel to hold the cargo in place. The interior compartment 84 may contain any type of storage configuration known to those skilled in the art, including shelves and straps that can be rearranged by the user to meet a specific need.

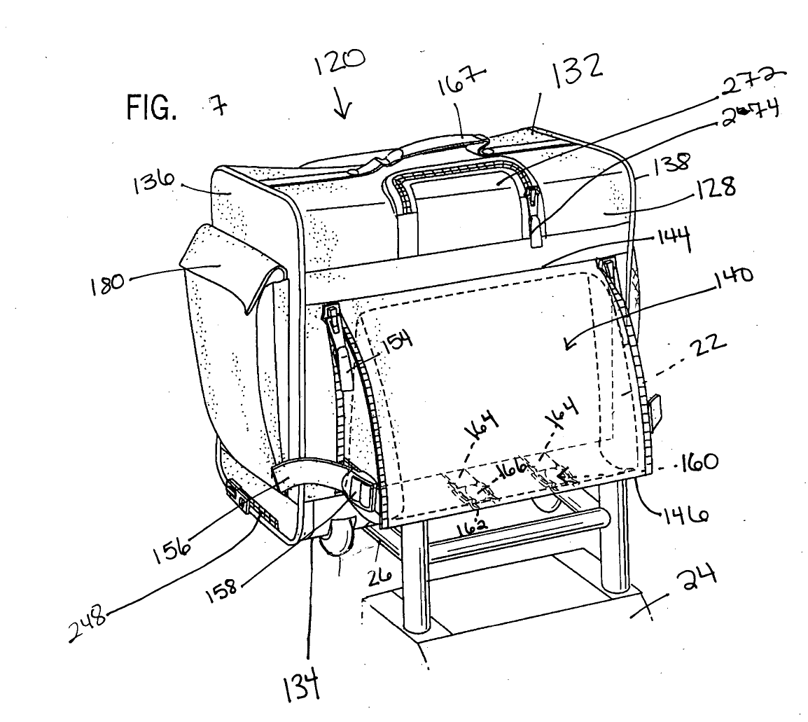

FIGS. 7 through 11 illustrate an alternate embodiment of the present invention. Similar corresponding parts to the embodiment shown in FIGS. 1 through 6, will be shown incremented by 100 in FIGS. 7 through 11.

As illustrated in FIG. 7, the expandable pocket 140 is located on the front side 128 of the motorcycle bag 120 and is adapted to securely engage the motorcycle's sissy bar 22. As described herein, the pocket 140 may be manufactured in a number of sizes to fit the sissy bars of various models and sizes of motorcycles. The first and second side ends 136 and 138 of the motorcycle bag 120 can include internal pockets 248 which can be used to store detachable straps, such as the hold down straps 160 or the tightening straps 156 when not in use.

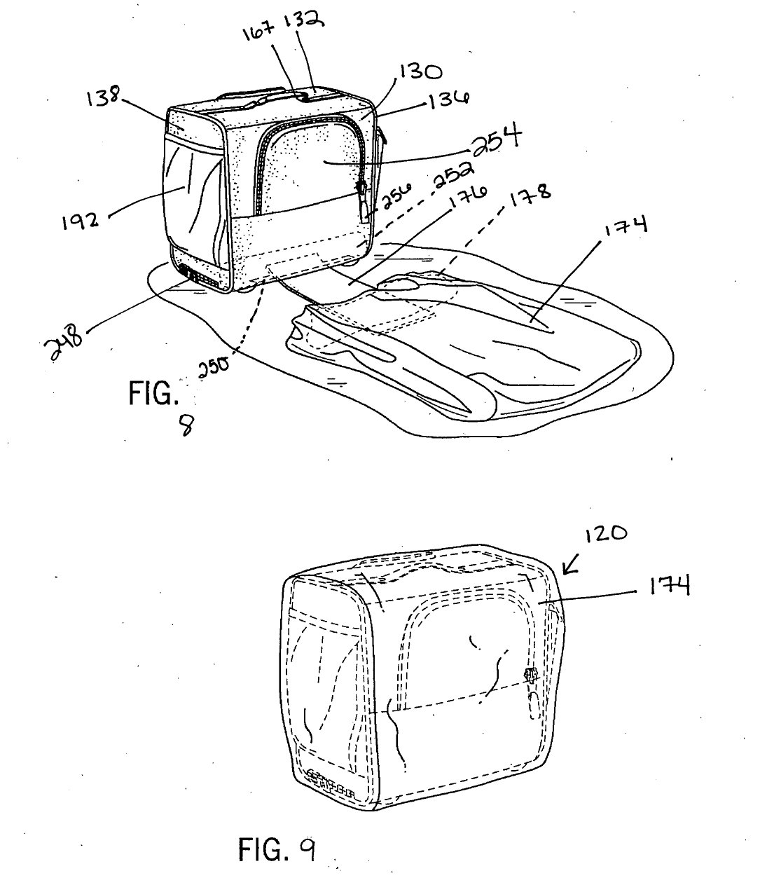

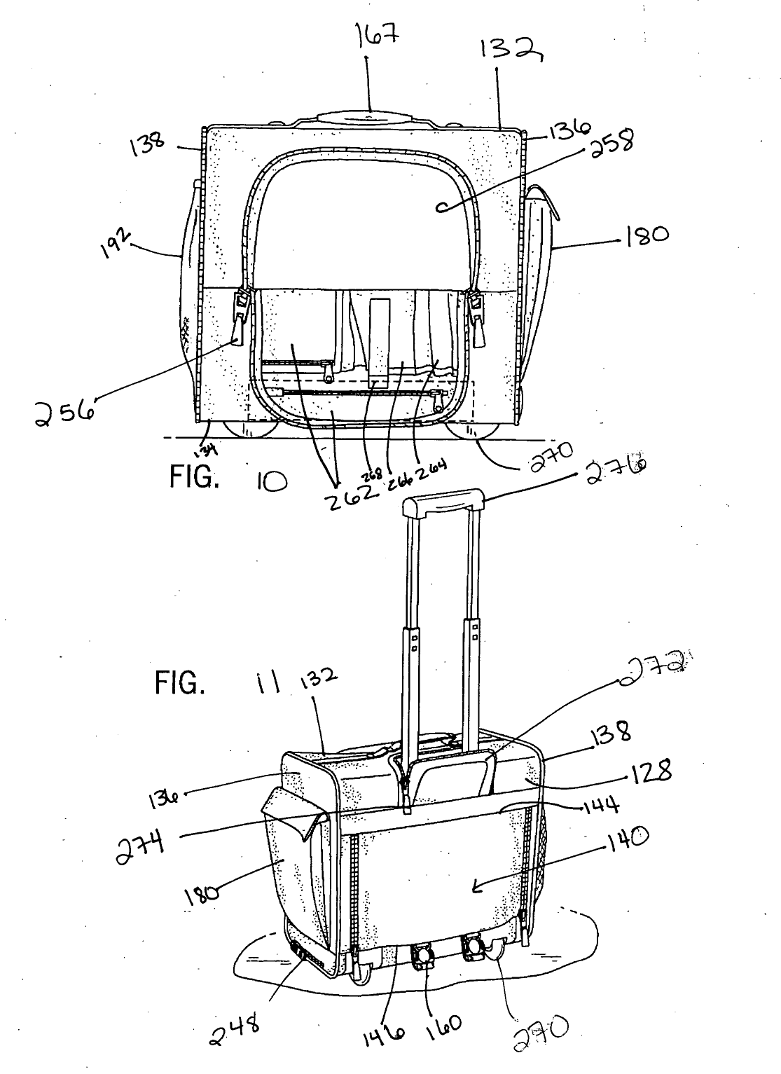

The back side 130 of the motorcycle bag 120 is illustrated in FIGS. 8 through 10. The back side 130 includes an internal compartment 252 which contains a rain cover 174. When not in use, the rain cover 174 can be folded up and completely stored within the compartment 252 which can be sealed closed by a zipper 250, as shown in FIGS. 8 and 10. The element 176 connects the rain cover 174 within the compartment 252 and secures the rain cover 174 to the motorcycle bag 120. Preferably, the element 176 is constructed of a resilient or elastic material to facilitate positioning of the rain cover on to the motorcycle bag 120. The rain cover 174 also includes drawstring or elastic portion 178 that can be used to tighten and secure the rain cover 174 around the motorcycle bag 120 when the rain cover 174 is installed. FIG. 9 illustrates the rain cover 174 installed on the motorcycle bag 120.

To access the contents of the motorcycle bag 120, the back side 130 also includes an access panel 254 which is retained closed by zipper 256. As best shown in FIG. 10, opening the access panel 254 reveals an internal storage compartment 258 of the motorcycle bag 20 for retaining the personal belongings of the rider. In addition, the access panel 254 has an internal surface 260 which contains change compartments 262, glasses case 264, cellular phone compartment 266 and clips 268. As will be readily apparent to those skilled in the art, the internal surface 260 may include any type and/or configuration of pockets, pouches, compartments, clips, hooks and/or storage means known to those skilled in the art.

To facilitate mobility of the motorcycle bag 120 when not secured to the motorcycle 24, the motorcycle bag 120 also includes wheels 270 located in the bottom side 134 of the motorcycle bag 120 near the front side 128 of the bag 120. A pocket 272 including a zipper 274 is included on the top side 132/front side 128 of the bag 120 for containing a pull-out handle 276 (as shown in FIG. 11). Thus, the motorcycle bag 120 of the present invention can be conveniently used as a “pull behind” piece of luggage. It can easily be transported when not attached to the motorcycle, and can be easily taken into hotels or checked onto an airplane, similar to conventional pieces of luggage.

Although an exemplary embodiment of the present invention has been shown and described with reference to particular embodiments and applications thereof, it will be apparent to those having ordinary skill in the art that a number of changes, modifications, or alterations to the invention as described herein may be made, none of which depart from the spirit or scope of the present invention. All such changes, modifications, and alterations should therefore be seen as being within the scope of the present invention.

1. Motorcycle luggage for removable attachment to a sissy bar of a motorcycle, said luggage comprising:
an enclosure having a front, a back, a top, a bottom, and opposing lateral side walls; and
an adjustable pocket affixed to said front of said enclosure, said adjustable pocket expandable from a closed position to an open position, said adjustable pocket being configurable to securely accommodate the sissy bar.

2. The motorcycle luggage of claim 1, wherein said adjustable pocket comprises at least one fastening mechanism, permitting said adjustable pocket to be expanded from said closed position to said open position and collapsed from said open position to said closed position.

3. The motorcycle luggage of claim 2, wherein said fastening mechanism comprises at least one zipper.

4. The motorcycle luggage of claim 1, wherein said adjustable pocket further comprises at least one adjustable strap attached to said pocket for securely tightening said pocket around the sissy bar.

5. The motorcycle luggage of claim 1, wherein said pocket has a top edge affixed to said front of said enclosure, a bottom edge and opposing lateral side edges, each of said lateral side edges expandably secured to said front of said enclosure with a fastening mechanism for adapting said pocket to tightly secure the sissy bar.

6. The motorcycle luggage of claim 1, further comprising quick release straps attached to said enclosure and adapted to engage the motorcycle.

7. The motorcycle luggage of claim 1, further comprising at least one wheel rotatably secured to one of said bottom, said front and said back of said enclosure to facilitate movement of said luggage.

8. The motorcycle luggage of claim 1, further comprising a handle attached to one of said top, said front and said back of said enclosure.

9. The motorcycle luggage of claim 8, wherein said top of said enclosure includes a handle seat formed therein, and wherein said handle is attached to said top of said enclosure, said handle movable between a retracted position wherein said handle rests within said handle seat, and an expanded position wherein a portion of said handle projects from said handle seat.

10. The motorcycle luggage of claim 1, further comprising at least one storage compartment.

11. The motorcycle luggage of claim 10, further comprising a rain cover disposed within said storage compartment.

12. A motorcycle travel bag comprising:
an enclosure having an interior storage compartment and an exterior surface; and
an expandable pocket mounted to said exterior surface of said enclosure, said pocket including front, back, side, and bottom sections defining a cavity for accommodating a sissy bar of a motorcycle, said cavity having a variable capacity and an adjustment mechanism for varying the capacity of said cavity to tightly secure the sissy bar within said pocket.

13. The travel bag of claim 12, wherein said adjustment mechanism includes at least one zipper.

14. The travel bag of claim 12, wherein said expandable pocket further comprises at least one adjustable strap attached to said pocket.

15. The travel bag of claim 12, further comprising at least one handle mounted to said enclosure.

16. The travel bag of claim 15, wherein said handle is an extendable handle having a retracted position and an extended position.

17. The travel bag of claim 12, further comprising at least one wheel rotatably mounted to said enclosure.

18. A motorcycle bag configured to removably mount to motorcycle seat backs of different dimensions, said bag comprising:
an enclosure having an exterior surface and an interior compartment for storing items;
an expandable receptacle affixed to said exterior surface of said enclosure, said expandable receptacle comprising cavity having a variable capacity and a closure mechanism for varying said capacity; and
at least one strap attached to said enclosure, said strap including a fastening mechanism.

19. The bag of claim 18, wherein said expandable receptacle is a pocket.

20. The bag of claim 18, wherein said closure mechanism includes at least one zipper.

21. The bag of claim 18, further comprising at least one wheel rotatably mounted to said enclosure.

22. The bag of claim 18, further comprising a rain cover attached to said enclosure.

23. Motorcycle luggage configured to removably mount to motorcycle seat backs of different dimensions, said luggage comprising:
a bag having an exterior surface and a storage compartment therewithin; and
a variable luggage mounting system integrally secured to said exterior surface of said bag, said luggage mounting system including an expandable pocket having a collapsed configuration and an expanded configuration, said pocket comprising a closure mechanism for allowing said pocket to be expanded from its collapsed configuration to its expanded configuration and to at least one intermediate configuration between its collapsed configuration and its expanded configuration.

24. The motorcycle luggage as defined in claim 23, wherein said pocket has a top edge affixed to said exterior surface of said bag, a bottom edge and opposing lateral side edges, each of said lateral side edges expandably secured to said exterior surface of said bag with a fastening mechanism for adapting said pocket to tightly secure a seat back of a motorcycle.
